(19) United States
(12) Patent Application Publication
(10) Pub. No.: US 2007/0054546 A1
(43) Pub. Date: Mar. 8, 2007

(54) Fuse connection box

(75) Inventor: Eiji Higuchi, Yokkaichi-city (JP)

Correspondence Address: OLIFF & BERRIDGE, PLC, P.O. BOX 19928, ALEXANDRIA, VA, 22320, US

(73) Assignee: SUMITOMO WIRING SYSTEMS, LTD., Mie (JP)

(21) Appl. No.: 11/488,069

(22) Filed: Jul. 18, 2006

(30) Foreign Application Priority Data
Sep. 2, 2005 (JP) 2005-254921

(51) Int. Cl. H01R 3/00

(52) U.S. Cl. 439/500

(57) ABSTRACT

A pair of partitioning walls is formed inside a terminal accommodation space from an opening formed at one end of a fuse connection box to partition the space inside the fuse connection box into a pair of terminal accommodation chambers. A pair of lances to be locked to locking portions of terminal fittings is formed on distal ends of the partitioning walls. A guide groove for guiding an insertion direction of an unlocking jig is formed on an inner surface of a peripheral wall surrounding an accommodation chamber in a range from a distal end of a fuse insertion opening to positions of the lances. The unlocking jig is inserted into the fuse connection box along the guide groove. Thereby, an insertion direction of the unlocking jig and an insertion amount thereof are restricted. The unlocking jig flexes the lances to such an extent as to unlock the terminals from the lances.

### BACKGROUND

This application claims priority from Japanese Patent Application 2005-254921, filed Sep. 2, 2005, the entire contents of which are incorporated herein by reference.

The present invention relates to a fuse connection box. For example, the present invention relates to a fuse connection box into which a fuse is removably inserted from one side of the fuse connection box and into which terminal fittings connected to ends of electric wires disposed in a car body are inserted from the other side of the fuse connection box to connect the terminal fittings and input and output terminals of the fuse to each other. The fuse connection box is preferably used to accommodate a fuse which has a small height and approximately a quadrangular shape. Input and output terminals of the fuse connection box may be exposed from cut-outs disposed at left and right sides of a fuse body made of resin.

A fuse connection box of this kind is proposed and disclosed in Japanese Patent Application Laid-Open No. 2004-158256 (JP-A-2004-158256). As shown in FIGS. 7 and 8, a pair of female terminals 3 crimped to the ends of a pair of electric wires W is inserted into a pair of terminal accommodation chambers 2 of the fuse connection box 1 from openings formed at one end of the fuse connection box 1. Locking portions 4a provided at the free-end side a pair of lances 4 that project inside the terminal accommodation chamber 2 are locked to locking stepped portions 3a formed on the female terminals 3. The space communicating with the distal side of the terminal accommodation chambers 2 of the fuse connection box 1 is formed as a fuse accommodation chamber 5. The fuse 6 is removably inserted into the fuse accommodation chamber 5. Thereby the input terminal 6a and the output terminal 6b of the fuse 6 and the terminals 3 are connected with each other by fitting the terminals 6a, 6b and the terminals 3 to each other.

When the terminals 3 are removed from the fuse connection box 1, an unlocking jig (not shown) is inserted into the fuse connection box 1 from the free end side of the lances 4 to unlock the locking stepped portions 3a from the locking portions 4a by flexing the locking portions 4a. To prevent the lances 4 from flexing excessively, a contact member 7 is provided between the lances 4.

### SUMMARY

The fuse connection box 1 having the above-described construction disclosed in JP-A-2004-158256 does not have a guide portion for restricting the insertion direction of the unlocking jig. Therefore neither the insertion direction of the unlocking jig nor the insertion amount thereof is fixed. Therefore, it is possible that an operator may apply a larger force than necessary to the unlocking jig, consequently flexing the lances excessively and breaking them. Because neither the insertion direction of the unlocking jig nor the insertion amount is fixed, it is difficult to flex the lances to such an extent that the terminals can be unlocked from the lances. Thus the unlocking operation may impose an undue burden on the operator.

The present invention has been made in view of the above-described problem. Accordingly, it is an object of exemplary embodiments of the present invention to restrict an insertion direction of an unlocking jig and an insertion amount thereof to prevent the lances from being flexed excessively, but to allow them to be flexed sufficiently so that an operator can unlock the terminal fittings from the lances without breaking the lances, allowing the operator to easily perform a terminal-unlocking operation without undue burden.

To achieve this object, exemplary embodiments of the present invention provide a fuse connection box with a terminal accommodation space accessible from a terminal insertion opening disposed at a first end of a fuse connection box housing to accommodate a pair of terminal fittings; and a fuse accommodation space accessible from a fuse insertion opening disposed at a second end of the fuse connection box housing to accommodate a fuse and to connect input and output terminals of the fuse with the pair of terminal fittings.

The fuse connection box housing includes a pair of partitioning walls disposed upward from the terminal insertion opening inside the terminal accommodation space, with the partitioning walls spaced from each other at a certain interval; a pair of terminal accommodation chambers surrounded with the partitioning walls and a peripheral wall of the housing; a pair of lances, to be locked to locking portions of the terminal fittings, which is provided on a pair of the partitioning walls; and a guide groove, for guiding an insertion direction of the unlocking jig, which is formed on an inner surface of a peripheral wall surrounding the fuse accommodation space in a range from a distal end of the fuse insertion opening to the positions of the lances.

In the above-described construction, the distal end of the unlocking jig inserted into the guide groove contacts distal ends of the lances and flexes the lances to such an extent that each terminal can be unlocked from the respective lance.

In the above-described construction, the unlocking jig is inserted into the fuse connection box along the guide groove to unlock a terminal from the respective lance. The guide groove restricts the insertion direction and amount of the unlocking jig, so that the unlocking jig is prevented from being inserted excessively.

When the unlocking jig inserted into the fuse accommodation space along the guide groove contacts the lance locked to the locking portion of the terminal, the lance is flexed to such an extent as to unlock the terminal from the lance. This prevents the lance from flexing excessively and being damaged.

The insertion direction of the unlocking jig along the guide groove is the same as to the unlocking direction. Thus this construction has a high operability in unlocking the terminal from the lance.

Further because the lance is formed integrally with the partitioning wall, this construction allows the fuse connection box to be compact.

It is preferable that the fuse to be accommodated in the fuse accommodation space has an input terminal and an output terminal parallel to each other, each terminal exposed from cut-outs disposed at left and right sides of a fuse body, and that a height of the fuse accommodation space is set so that the fuse body can be fitted therein.

Because the input terminal and the output terminal do not project from the fuse body, the height of the fuse can be made smaller than a fuse in which the terminals project from the fuse body. Consequently, the fuse connection box can be made compact and lightweight.

As apparent from the foregoing description, in the fuse connection box of embodiments of the invention, the insertion direction of the unlocking jig along the guide groove is the same as the terminal unlocking direction. Thus the embodiments allow the lance to be flexed in a constant amount which is appropriate for unlocking the terminal from the lance, thereby reducing the possibility that the lances are excessively flexed and possibly broken.

These and other objects, advantages and features are described in or apparent from the following detailed description.

### BRIEF DESCRIPTION OF THE DRAWINGS

Exemplary embodiments will be described in connection with the attached drawings, in which like numerals represent like parts, and in which:

FIG. 1 is a sectional view, taken along a line A-A of FIG. 3, showing a fuse connection box of a first embodiment of the present invention;

FIG. 2 is a main part-enlarged sectional view seen in a direction shown with an arrow (as seen from the left side) of FIG. 1;

FIG. 3 is a plan view showing the fuse connection box of the first embodiment of the present invention;

FIG. 4 is a sectional view showing a state in which a fuse and terminal fittings connected to ends of electric wires are inserted into the fuse connection box of the first embodiment to connect the fuse and the terminal fittings to each other;

FIG. 5 is a sectional view showing an operation of unlocking terminal fittings connected to the ends of electric wires from lances provided inside the fuse connection box;

FIG. 6A is a perspective view showing an unlocking jig which is used in the first embodiment;

FIG. 6B is a perspective view showing enlarged main parts of FIG. 6A;

FIG. 7 is a perspective view showing a conventional fuse box;

FIG. 8A is a sectional view showing the conventional fuse box shown in FIG. 7; and

FIG. 8B is a bottom view showing the conventional fuse box shown in FIG. 7.

### DETAILED DESCRIPTION OF EMBODIMENTS

Exemplary embodiments of the present invention will be described below with reference to drawings.

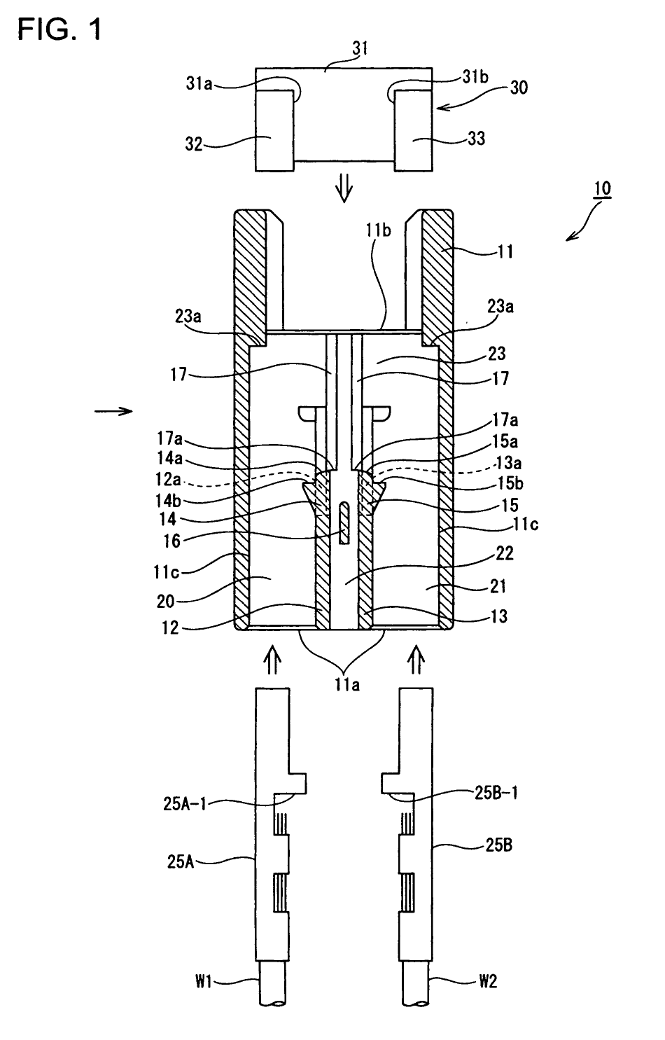

FIGS. 1 through 6 show a first embodiment of the present invention.

As shown in FIG. 1, a fuse connection box 10 has a function of connecting a fuse 30 and a pair of electric wires W (W1, W2) to each other. An opening at one end of a square pillar-shaped (or other-shaped) accommodation chamber 11 is formed as a terminal fitting insertion opening 11a for a pair of terminal fittings (hereinafter referred to as terminals) 25A, 25B crimped to ends of the electric wires W1, W2 respectively. Another opening is formed at the other end of the accommodation chamber 11 as a fuse insertion opening 11b.

Inside the accommodation chamber 11, a terminal accommodation space at the side of the terminal fitting insertion opening 11a is partitioned with a pair of partitioning walls 12, 13 to form a pair of terminal accommodation chambers 20, 21 and a penetration space 22 sandwiched between the partitioning walls 12 and 13. Inside the accommodation chamber 11, a space at the side of the fuse insertion opening 11b is formed as a fuse accommodation space 23 communicating with a pair of the terminal accommodation chambers 20, 21.

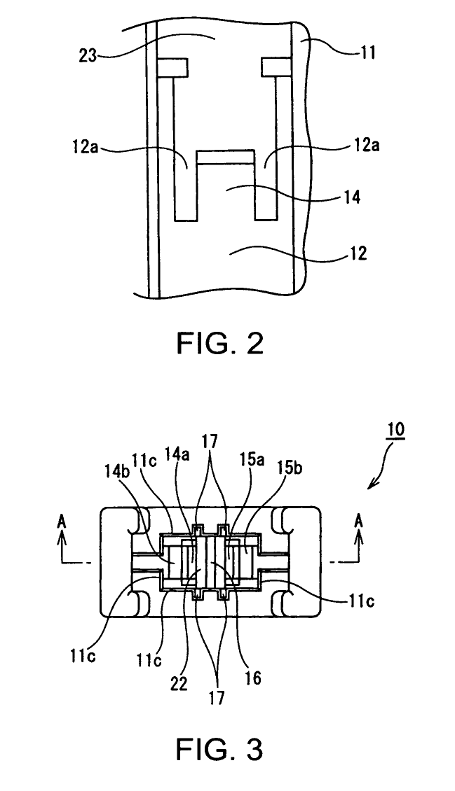

As shown in FIG. 2, two slits 12a, are defined in the partitioning wall 12 from approximately a vertically central position thereof toward the fuse insertion opening 11b to form a lance 14. A lance 15 is formed by slits 13a, 13a defined in the partitioning wall 13 in the same manner. The lances 14, 15 have circular arc-shaped contact surfaces 14, 15a, respectively (see FIG. 1), disposed at distal sides thereof and locking surfaces 14b, 15b projected from lower ends of the contact surface 14a, 15a respectively. Each of the lances 14, 15 is capable of elastically deforming, with a free end disposed at the distal side thereof and with a fixed end disposed at the proximal side of the slits 12a, 13a.

Female terminals 25A, 25B crimped to the ends of the electric wires W1, W2, respectively, are inserted into a pair of the terminal accommodation chambers 20, 21 surrounded with the partitioning walls 12, 13 and a peripheral wall 11c of the accommodation chamber 11 from the terminal fitting insertion opening 11a. The locking surfaces 14b, 15b of the lances 14, 15 are locked to locking portions 25A-1, 25B-1, respectively, formed on the terminals 25A, 25B. Thereby the terminals 25A, 25B are fixedly held inside the terminal accommodation chambers 20-21, respectively.

The dimension of the fuse accommodation space 23 disposed above the locking surfaces 14b, 15b of the lances 14, 15 is set so that the fuse 30 can be removably inserted thereinto. The fuse 30 is similar to that disclosed in JP-A-2004-158256. More specifically, the fuse 30 is approximately rectangular and has a small height (so-called low fuse). An input terminal 32 and an output terminal 33 parallel therewith are exposed from cut-outs 31a, 31b disposed at left and right sides of the fuse body 31 made of resin. A stepped portion 23a to which an upper end surface of the fuse body 31 is locked is formed on an inner surface of the upper end of the fuse accommodation space 23.

A guide groove 17 for guiding the insertion of the unlocking jig (not shown) is formed on an inner surface of each of the peripheral walls 11c surrounding the accommodation chamber 11 in a range from the fuse insertion opening 11b to the positions of the lances 14, 15. The distal ends of the contact surfaces 14a, 15a of the lances 14, 15 are coincident with termination portions 17a of the guide grooves 17.

As shown in FIG. 3, the guide grooves 17 may be quadrangular in section. The guide grooves 17 are formed on each of the opposed peripheral walls 11c. In some embodiments of the invention, the number of the guide grooves 17 is four.

A flexing restraining member 16 is provided in the penetration space 22 sandwiched between the partitioning walls 12 and 13 at a position in the vicinity of the proximal portions of the lances 14, 15. As shown in FIG. 3, the flexing restraining member 16 is formed like a beam between the opposed peripheral walls 11c of the accommodation chamber 11.

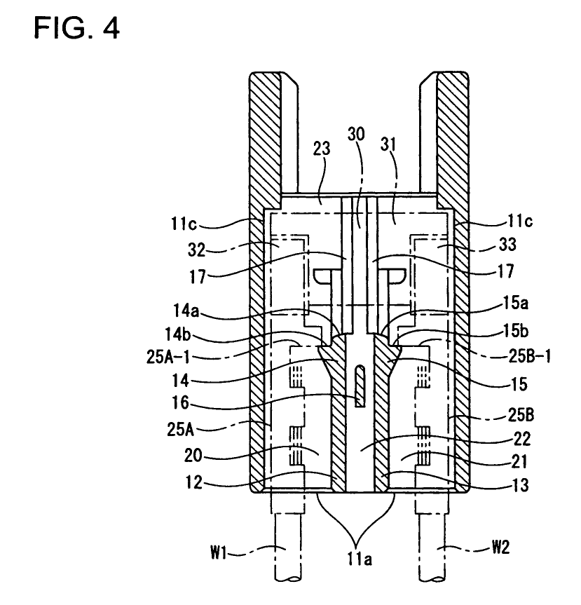

In the fuse connection box 10 having the above-described construction, as shown in FIG. 4, the female terminals 25A, 25B are inserted into the terminal accommodation chambers 20, 21, respectively, and locked to the lances 14, 15, respectfully. When the fuse 30 is inserted into the fuse accommodation space 23 from the fuse insertion opening 11b in this state, the female terminals 25A and 25B crimped to the ends of the electric wires W1, W2, respectively, are fitted in the input terminal 32 and the output terminal 33, respectively, of the fuse 30. The fuse 30 and the electric wires W1, W2 are thereby electrically connected with each other.

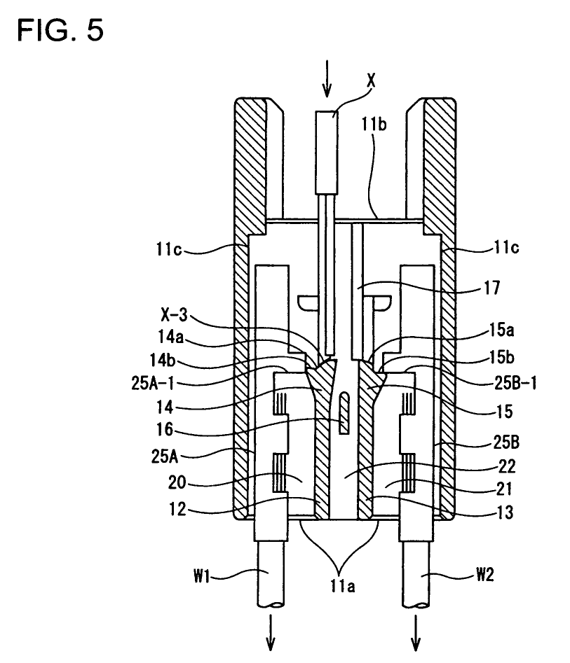

To remove the female terminals 25A, 25B from the fuse connection box 10, the fuse 30 is first pulled out of the fuse insertion opening 11b. Thereafter, as shown in FIG. 5, an unlocking jig X is inserted into the fuse accommodation space 23 from the fuse insertion opening 11b.

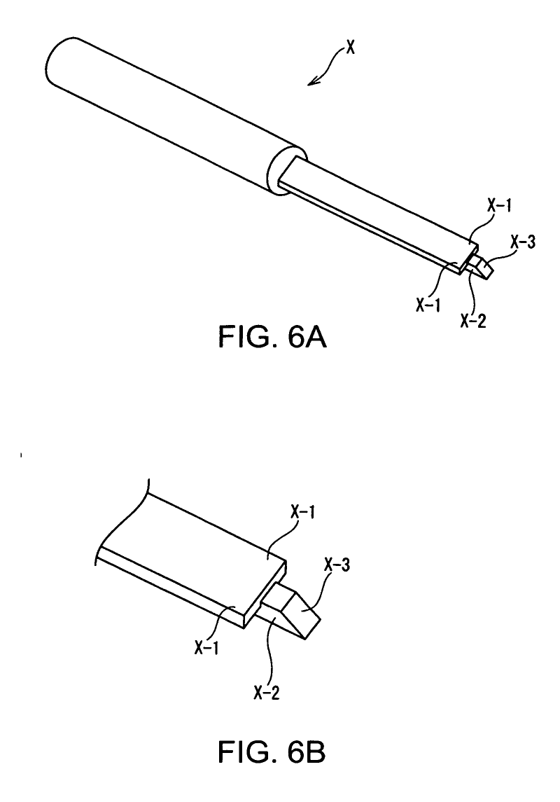

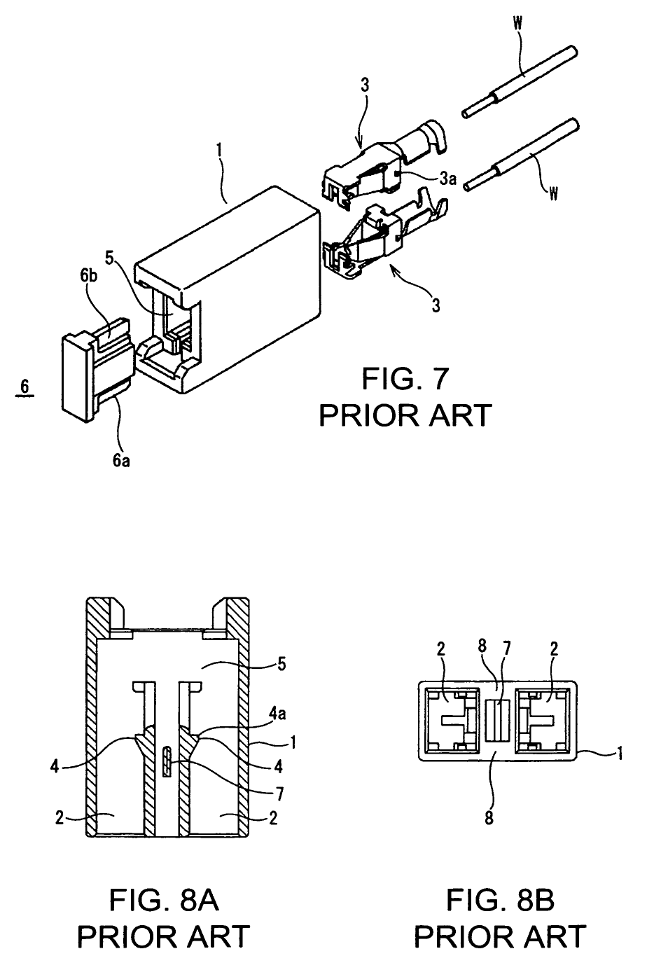

As shown in FIGS. 6A and 6B, the unlocking jig X is T-shaped in section and composed of a side part X-1 and a central part X-2. The distal end of the central part X-2 is formed as an inclined portion X-3. The unlocking jig X is inserted into the fuse accommodation space 23 with the side part X-1 thereof in contact with the guide groove 17. When the unlocking jig X is inserted into the fuse accommodation space 23 for a predetermined distance, the inclined portion X-3 contacts the contact surfaces 14a, 15a of the lances 14, 15, and the unlocking jig X stops inserting into the fuse accommodation space 23. At this time, the lances 14, 15 are pressed at the inclined portion X-3. As a result, the lances 14, 15 flex to a side opposite to the locking side and the terminals 25A, 25B are unlocked from the lances 14, 15, respectively. The terminals 25A, 25B then can be pulled out of the terminal insertion opening 11a.

As described above, the fuse connection box of exemplary embodiments of the present invention includes the guide groove 17. Thus by inserting the side part X-1 of the unlocking jig X into the guide groove 17, the insertion direction of the unlocking jig X is restricted, and the side part X-1 is stopped at the termination portion 17a of the guide groove 17. Therefore the insertion amount of the unlocking jig X is restricted and it consequently is possible to prevent the unlocking jig X from being inserted obliquely. At the stop position of the unlocking jig X, the terminals are unlocked from the lances. That is, when the lances 14, 15 are flexed toward the side opposite to the locking side by pressing them a little toward the unlocking side at the stop position, the terminals 25A, 25B can be unlocked from the lances 14, 15, respectively. Even though the lances 14, 15 are pressed excessively, the flexing restraining member 16 disposed in the vicinity of the proximal portions of the lances 14, 15 prevents the lances 14, 15 from being excessively flexed.

Consequently, it is possible to unlock the terminals 25A, 25B from the lances 14, 15 without flexing the lances 14, 15 excessively or possibly breaking them.

Further, because the unlocking jig X is inserted into the fuse accommodation space along the guide groove 17, embodiments of the invention having this feature have a high operability in unlocking the terminals from the lances and hence reduces the burden imposed on an operator.

Furthermore because the height of the fuse 30 connected with ends of electric wires is small compared to a fuse where the terminals extended from the fuse body, the fuse connection box 10 may be compact and lightweight. Therefore, the fuse connection box 10 may be able to be manufactured at a reduced cost.

Although the invention has been described with reference to specific embodiments, those embodiments should be viewed as illustrating and not limiting. Various modifications, substitutions and improvements are possible within the spirit and scope of the invention.

What is claimed is:

1. A fuse connection box with a terminal accommodation space accessible from a terminal insertion opening disposed at a first end of a fuse connection box housing to accommodate a pair of terminal fittings; and a fuse accommodation space accessible from a fuse insertion opening disposed at a second end of the fuse connection box housing to accommodate a fuse and to connect input and output terminals of the fuse with said the pair of terminal fittings,
said fuse connection box housing comprising:
a pair of partitioning walls formed inside said terminal accommodation space from said terminal insertion opening, with said partitioning walls spaced from each other at a certain interval;
a pair of terminal accommodation chambers defined by said partitioning walls and a peripheral wall of said housing;
a pair of lances, to be locked to locking portions of said terminal fittings, which is provided on a pair of said partitioning walls; and
a guide groove, for guiding an insertion direction of an unlocking jig, which is formed on an inner surface of a peripheral wall that surrounds said fuse accommodation space in a range from a distal end of said fuse insertion opening to positions of said lances,
wherein a distal end of said unlocking jig inserted into said guide groove contacts distal ends of said lances and flexes said lances to such an extent that said terminals can be unlocked from said lances.

2. A fuse connection box according to claim 1, wherein said fuse to be accommodated in said fuse accommodation space comprises an input terminal and an output terminal parallel therewith both exposed from cut-outs disposed at left and right sides of a fuse body; and a height of said fuse accommodation space is set so that said fuse body can be fitted therein.
